(19) United States
(12) Patent Application Publication
(10) Pub. No.: US 2024/0270441 A1
(43) Pub. Date: Aug. 15, 2024

(54) FRAMELESS INNER ENCLOSURE FOR EQUIPMENT CASE

(71) Applicant: Becklin Holdings, Inc., Grants Pass, OR (US)

(72) Inventors: Dennis Sterling Becklin, Grants Pass, OR (US); Spencer E. Adams, Medford, OR (US); Brian C. Rushing, Grants Pass, OR (US)

(21) Appl. No.: 18/109,821

(22) Filed: Feb. 14, 2023

(51) Int. Cl. B65D 6/06

(52) U.S. Cl. CPC B65D 7/10; B65D 9/08; B65D 11/12

(57) ABSTRACT

A substantial cuboid outer case has two or more inner rails mounted thereto by shock absorbers. An inner enclosure has sliders mounted directly to and contacting outer surfaces thereof, the sliders engaging the two or more rails. Clips retain the sliders in engagement with the rails when the inner enclosure is positioned within the outer case. The clips may include a pin that passes through both a slider and a panel of the inner enclosure. The inner enclosure may include a stack of two or more enclosures with sliders on the top and bottom enclosures.

### FIELD OF THE INVENTION

This application relates to cases for equipment and, more particularly, to mounting an inner enclosure within an equipment case.

### BACKGROUND OF THE INVENTION

In many commercial and military applications, sensitive equipment must be transported to a worksite and may be used outdoors. Often, an outer case made of metal or a rugged polymer is used along with an inner enclosure made of rugged polymer or metal. The inner enclosure houses the sensitive equipment and is mounted to the outer case by shock absorbers.

It would be an advancement in the art to reduce the cost and complexity of manufacturing such an equipment case.

### SUMMARY OF THE INVENTION

In one aspect of the invention, an apparatus for storing equipment includes an outer case having a first substantially cuboid shape and two or more rails mounted within the outer case and defining a longitudinal direction. An inner enclosure is sized to insert within the outer case and includes a plurality of panels defining a second substantially cuboid shape. Two or more sliders are secured to the inner enclosure and directly interface with two or more outer surfaces of the plurality of panels, the two or more sliders configured to engage the two or more rails when the inner enclosure is inserted within the outer case along the longitudinal direction.

The two or more rails may have a substantially constant cross section perpendicular to the longitudinal direction. The two or more sliders may have a substantially constant cross section perpendicular to the longitudinal direction. The two or more sliders may each include a base and sides extending outwardly from the base perpendicular to the longitudinal direction. The two or more sliders may include protrusions extending inwardly from the sides, each rail positioned between the sides and under the protrusions of one slider of the two or more sliders when the inner enclosure is inserted within the outer case along the longitudinal direction.

No intervening frame is positioned between the outer case and the inner enclosure or between the two or more sliders and the inner enclosure. Two or more locking mechanisms may be configured to prevent removal of the two or more sliders from engagement with the two or more rails when the inner enclosure is inserted within the outer case along the longitudinal direction. Each locking mechanism of the two or more locking mechanisms may include a spring arm and a pin, the spring arm configured to urge the pin into engagement with a rail of the two or more rails and a slider of the two or more sliders engaged with the rail of the two or more rails. Each slider of the two or more sliders may define a slider opening sized to receive the pin of one of the two or more locking mechanisms and the plurality of panels define two or more panel openings each aligned with the slider opening of one of the two or more sliders.

The inner enclosure may be one of a plurality of inner enclosures stacked together. The two or more sliders may include one or more upper sliders mounted to a top inner enclosure of the plurality of inner enclosures and one or more lower sliders mounted to a lower inner enclosure of the plurality of inner enclosures.

A method for storing equipment may include providing an outer case having a first substantially cuboid shape and having two or more rails mounted within the outer case and defining a longitudinal direction. An inner enclosure is provided that is sized to insert within the outer case and including a plurality of panels defining a second substantially cuboid shape, the inner enclosure having two or more sliders secured thereto and directly interfacing with two or more outer surfaces of the plurality of panels. The two or more sliders are aligned with the two or more rails. The two or more sliders are slid into engagement with the two or more rails with the inner enclosure positioned within the outer case.

The two or more rails may have a substantially constant cross section perpendicular to the longitudinal direction. The two or more sliders may have a substantially constant cross section perpendicular to the longitudinal direction. The two or more sliders may each include a base and sides extending outwardly from the base perpendicular to the longitudinal direction. The two or more sliders may each include protrusions extending inwardly from the sides, each rail positioned between the sides and under the protrusions of one slider of the two or more sliders when the inner enclosure is inserted within the outer case along the longitudinal direction.

No intervening frame is positioned between the outer case and the inner enclosure or between the two or more sliders and the inner enclosure when the inner enclosure is positioned within the outer case. The method may include engaging two or more locking mechanisms with the two or more rails and two or more sliders to prevent disengagement of the two or more rails when the inner enclosure is inserted within the outer case along the longitudinal direction. Each locking mechanism of the two or more locking mechanisms may include a spring arm and a pin. The method may further include biasing, by the spring arm of each locking mechanism, the pin of each locking mechanism into engagement with both of one of the two or more rails and one of the two or more sliders.

Each locking mechanism of the two or more locking mechanisms may include a spring arm and a pin. The method may include biasing, by the spring arm of each locking mechanism, the pin of each locking mechanism through a first opening in one of the two or more slider and a second opening in one of the two or more rails.

The inner enclosure may be one of a plurality of inner enclosures. The method may include securing the plurality of inner enclosures to one another having one or more upper sliders of the two or more sliders mounted to a top inner enclosure of the plurality of inner enclosures and one or more lower sliders of the two or more sliders mounted to a lower inner enclosure of the plurality of inner enclosures.

### BRIEF DESCRIPTION OF THE DRAWINGS

Preferred and alternative examples of the present invention are described in detail below with reference to the following drawings:

FIG. 1 is an isometric view of an outer case having inner rails.

FIG. 2 is an isometric view of an inner enclosure for frameless mounting within the outer case in accordance with an embodiment of the present invention.

FIG. 3 is an exploded view of the inner enclosure in accordance with an embodiment of the present invention.

FIG. 4A is a cross-sectional view showing mounting of the inner enclosure to the outer case in accordance with an embodiment of the present invention.

FIG. 4B is an isometric view of a rail for mounting to the interior of the outer case.

FIG. 4C is an isometric view of a locking clip.

FIG. 5A is an isometric view of a stackable inner enclosure in accordance with an embodiment of the present invention.

FIG. 5B is an isometric view of stacked inner enclosures in accordance with an embodiment of the present invention.

FIG. 6 is an isometric view of an inner enclosure including a plurality of windows in accordance with an embodiment of the present invention.

FIG. 7A is an isometric view of an inner enclosure in process of inserting into the outer case in accordance with an embodiment of the present invention.

FIG. 7B is an isometric view of the inner enclosure positioned within the outer case in accordance with an embodiment of the present invention.

### DETAILED DESCRIPTION OF THE PREFERRED EMBODIMENT

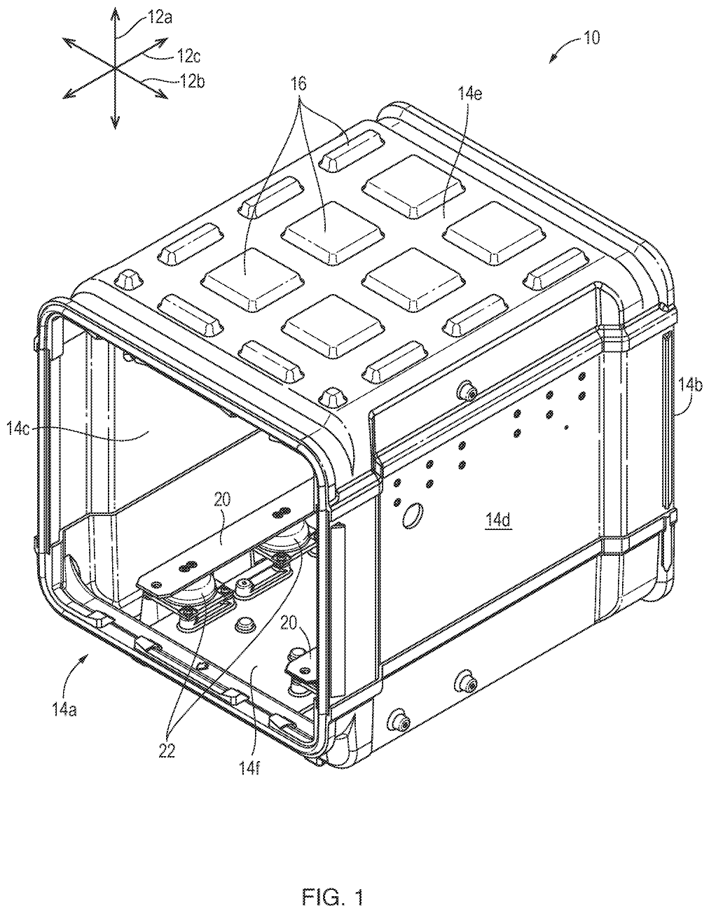

Referring to FIG. 1, an outer case 10 may be understood with respect to a vertical direction 12a, horizontal direction 12b, and a longitudinal direction 12c that are all substantially perpendicular to one another. The directions 12a, 12b, 12c are defined to enable the description of components relative to one another but do not necessarily correspond to vertical, horizontal, and longitudinal directions during use.

The outer case 10 may have a substantially cuboid shape with rounding at the corners, protrusions extending outwardly form the cuboid shape, and/or recesses extending inwardly from the cuboid shape. Accordingly, each panel of the outer case 10 may lie substantially within a plane corresponding to a side of the cuboid shape. As used herein “substantially within” a plane shall be understood as 80 percent of a panel lying within 0.1×L of the plane, where L is the longest dimension of the outer case 10 along any of the directions 12a, 12b, 12c.

The outer case 10 may define a front opening 14a substantially within a first plane parallel to the vertical direction 12a and the horizontal direction 12b. The front opening 14a may be covered by a lid (not shown) according to any approach known in the art. The outer case 10 may include a rear panel 14b substantially within a second plane parallel to the vertical direction 12a and the horizontal direction 12b and offset from the first plane along the longitudinal direction 12c. A lid covering the front opening 12a may have an identical configuration as the rear panel 14b.

The outer case 10 may include a left panel 14c substantially within a third plane parallel to the vertical direction 12a and the longitudinal direction 12c. The outer case 10 may include a right panel 14d substantially within a fourth plane parallel to the vertical direction 12a and the longitudinal direction 12c and offset from the third plane along the horizontal direction 12b. The outer case 10 may include a top panel 14e substantially within a fifth plane parallel to the horizontal direction 12b and the longitudinal direction 12c. The outer case 10 may include a bottom panel 14f substantially within a sixth plane parallel to the horizontal direction 12b and the longitudinal direction 12c and offset from the fifth plane along the vertical direction 12a.

Two or more of the panels 14b-14f may be formed of a monolithic sheet of material. Some or all of the panels 14b-14f may be separate pieces of material adhered, welded, or otherwise fastened to one another. The panels 14b-14f may include metal, rugged polymer, wood, composite (fiberglass, carbon fiber, Kevlar, etc.), or other type of material. The panels 14b-14f, particularly the top and bottom panels 14e, 14f, may include features 16 to facilitate stacking with other outer cases 10. The panels 14b-14f, such as the left and right panels 14c, 14d, may have features secured thereto or formed thereon, such as handles for carrying or fasteners for securing the outer case 10 to another case 10 above or below the outer case 10.

Inner surfaces of one or more of the panels 14b-14f may have one or more rails 20 mounted thereto. The rails 20 may be oriented having the long dimension, i.e., the direction along which an object mounted to the rails 20 will slide, substantially (e.g., within 5 degrees of) parallel to the longitudinal direction 12c. The rails 20 may be mounted to one or more of the panels 14b-14f by means of shock absorbers 22, such as two or more shock absorbers 22 per rail 20. For example, the shock absorbers 22 may include a flexible polymer, such as between 40 and 80 Shore A hardness. For example, each rail 20 may be mounted to one of the panels 14b-14f by two or more shock absorbers 22 offset from one another.

In the illustrated embodiment, the rails 20 include two rails 20 mounted to the bottom panel 14f. An additional two rails 20 may be mounted to the top panel 14e in the same manner as shown for the rails 20 mounted to the bottom panel 14f. The two rails 20 mounted to a same panel 14e, 14f may be offset from one another in the horizontal direction 12b by a distance that is between 0.5 and 0.9 times the separation between the left and right panels 14c, 14d in the horizontal direction 12b.

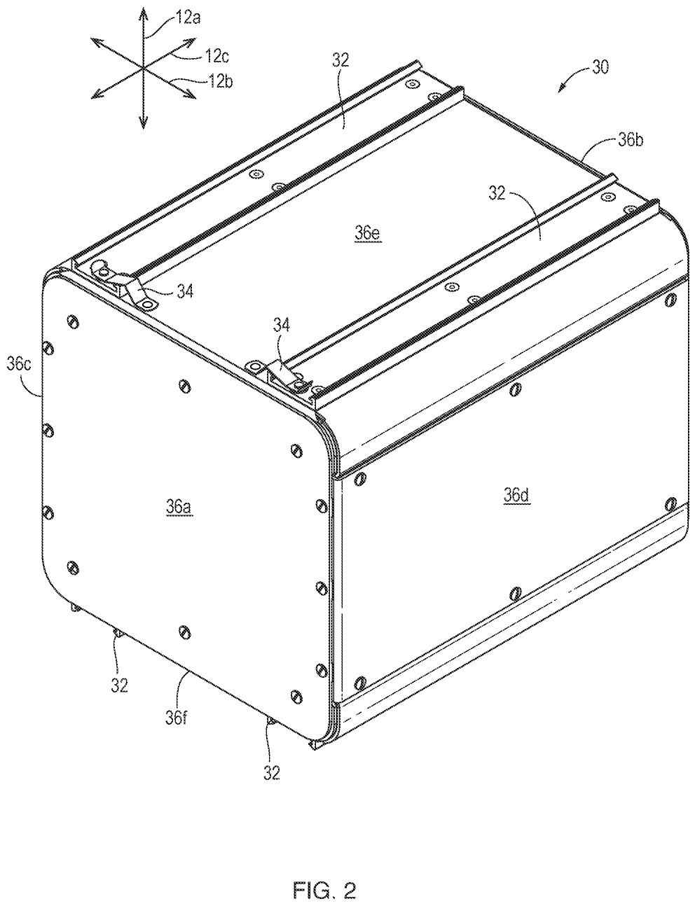

Referring to FIG. 2, an inner enclosure 30 is positionable within the outer case 10. The inner enclosure 30 has slides 32 mounted thereto such that each slide 32 engages one of the rails 20 when the inner enclosure 30 is positioned within the outer case 10. A clip 34 is mounted on or adjacent each slide 32 and engages the rail 20 engaged with the slide 32 in order to resist movement of the rail 20 with respect to the slide 32 along the longitudinal direction 12c. As an alternative, the clip 34 may be mounted to the outer case 10 and engage the slide 32. The clip 34 may be a selectively releasable fastener. The fastening function of the clip 34 may be implemented using screws or any other type of fastener. Note that in some implementations, a single clip 34 is sufficient to retain the inner enclosure 30 within the outer case 10.

The inner enclosure 30 may have a substantially cuboid shape with rounding at the corners, protrusions extending outwardly form the cuboid shape, and/or recesses extending inwardly from the cuboid shape. Accordingly, each panel of the inner enclosure 30 may lie substantially within a plane corresponding to a side of the cuboid shape. As used herein “substantially within” a plane shall be understood as 80 percent of a panel lying within 0.1×M of the plane, where M is the longest dimension of the inner enclosure 30 along any of the directions 12a, 12b, 12c.

The inner enclosure 30 may include a front panel 36a substantially within a first plane parallel to the vertical direction 12a and the horizontal direction 12b. The front panel 36a may be removable to function as a lid or access panel. The front panel 36a may be exposed when the opening 14a is uncovered. Accordingly, the front panel 36a may have buttons, switches, screens, ports, or other structures mounted thereto for enabling access to the functionality of a component contained within the inner enclosure 30. The inner enclosure 30 may include a rear panel 36b substantially within a second plane parallel to the vertical direction 12a and the horizontal direction 12b and offset from the first plane along the longitudinal direction 12c. The rear panel 14b may be identical or a mirrored version of the front panel 14a.

The inner enclosure 30 may include a left panel 36c substantially within a third plane parallel to the vertical direction 12a and the longitudinal direction 12c. The inner enclosure 30 may include a right panel 36d substantially within a fourth plane parallel to the vertical direction 12a and the longitudinal direction 12c and offset from the third plane along the horizontal direction 12b. The inner enclosure 30 may include a top panel 36e substantially within a fifth plane parallel to the horizontal direction 12b and the longitudinal direction 12c. The inner enclosure 30 may include a bottom panel 36f substantially within a sixth plane parallel to the horizontal direction 12b and the longitudinal direction 12c and offset from the fifth plane along the vertical direction 12a.

Two or more of the panels 36a-36f may be formed of a monolithic sheet of material. Some or all of the panels 36a-36f may be separate pieces of material adhered, welded, or otherwise fastened to one another. The panels 36a-36f may include metal, rugged polymer, wood, composite (fiberglass, carbon fiber, Kevlar, etc.), or other type of material. The panels 36a-36f may provide a degree of electromagnetic shielding to an electronic component positioned within the inner enclosure 30 and may therefore be made of metal such as steel or aluminum.

Outer surfaces of two or more of the panels 36a-36f have the slides 32 mounted thereto. The slides 32 are mounted to the outer surfaces of the two or more panels without an intervening frame. The slides may be mounted to the outer surfaces of the two or more panels such that the lower surface of each slide 32 directly contacts and interfaces with the outer surface to which the slide 32 is mounted.

The slides 32 may be oriented having the long dimension, i.e., the direction along which the slide 32 will slide relative to the rails 20, substantially (e.g., within 5 degrees of) parallel to the longitudinal direction 12c. The slides 32 may be embodied as extruded plastic, metal, or composite structures having substantially constant cross section in a plane perpendicular to the longitudinal direction 12c along substantially all (e.g., at least 90 percent) of the length thereof. The term “substantially constant” may be interpreted as meaning constant with the exception of variation inherent in the manufacturing process and features formed in the slides 32, such as holes for fasteners or for engaging a clip 34. The lower surface of the slider 32 contacting an outer surface of one of the panels 36a-36f is an outer surface of the substantially constant cross-sectional shape defined by the slide 32 in planes perpendicular to the longitudinal direction 12a.

In the illustrated embodiment, the slides 32 include two slides 32 mounted to the top panel 36e and two slides 32 mounted to the bottom panel 36f. The two rails mounted to a same panel 36e, 36f may be offset from one another in the horizontal direction 12b by a distance that is between 0.5 and 0.9 times the separation between the left and right panels 36c, 36d in the horizontal direction 12b. The separation along the horizontal direction 12b between the slides 32 secured to the same panel 36e, 36f may be substantially the same (e.g., within 2 mm) as the separation between the rails 20 secured to the same panel 36e, 36f of the outer case 10.

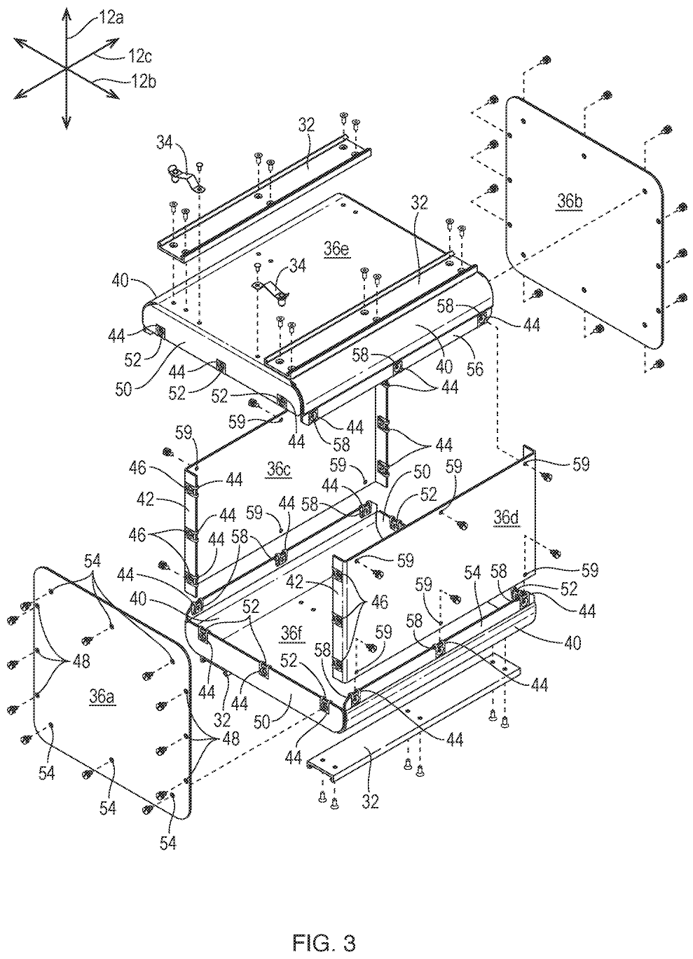

FIG. 3 illustrates an example configuration of pieces that may be assembled to form the inner enclosure 30. In the illustrated configuration, each panel 36a-36f is a separate piece and the pieces may be fastened to one another to form the inner enclosure 30. The illustrated configuration is exemplary only and any two or more of the illustrated pieces may be formed monolithically. For example, the front panel 36a may be removable to facilitate installing equipment inside the enclosure whereas any two or more of the remaining panels 36b-36f are formed of a single monolithic piece of material.

Part of some or all of the left panel 36c, right panel 36d, top panel 36e, and bottom panel 36f may include rounded portions 40 to conform to the inner shape of the outer case 10 receiving the inner enclosure 30. In particular, any of the above-referenced panels may be rounded in a plane perpendicular to the longitudinal direction 12c. For example, the radius of curvature of a rounded portion 40 may be between 1 and 10 cm smaller than the corresponding radius of a rounded corner of the outer case 10 in which the rounded portion nests when the inner enclosure 30 is positioned within the outer case 10. The rounded portions 40 may additionally serve to stiffen and strengthen the inner enclosure 30, which facilitates the use of the inner enclosure 30 without an additional frame mounted within the outer case 30. In the illustrated embodiment, each of the top panel 36e and bottom panel 36f includes rounded portions 40 at each edge. The rounded portions 40 may have an angular extent of 90 degrees and a radius of curvature corresponding to the size of the outer case 10, such as between 3 and 20 cm.

In the illustrated embodiment, rounded portions are not present at a transition between the front panel 36a and the panels 36c, 36d, 36e, 36f or between the rear panel 36b and the panels 36c-36f. Instead, one or both of the front panel 36a and rear panel 36b may be planar panels that are removable to provide access to the interior of the inner enclosure 30. For example, the panels 36c, 36d define tabs 42 that engage the front panel 36a and rear panel 36b, such as by means of fasteners, such as screws or rivets, passing through openings 46 in the tabs 42 and openings 48 in the front and rear panels 36a, 36b. The tabs 42 may be formed by bending sheet metal constituting the panels 36e, 36f to which the tabs 42 are secured, by co-molding, or fastening the tabs 42 by means of screws, rivets welds, adhesive or other fastening means. Inasmuch as the panels 36a, 36b, 36c, 36e, 36e, 36f may be made of a thin sheet metal or plastic, nut clips 44 may be secured to the tabs 42 in order to provide a threaded opening for engaging a screw.

Alternatively or additionally, tabs 50 are secured to the top panel 36e and bottom panel 36f and engage the front and back panels 36a, 36b. The tabs 50 may define openings 52 that are aligned with openings 54 in the panels 36a, 36b and fasteners may be passed through the openings 52, 54 to secure the panels 36a, 36b to the panels 36e, 36f. The tabs 50 may be formed by bending sheet metal constituting the panels 36e, 36f to which the tabs 50 are secured, by co-molding, or by fastening the tabs 50 by means of screws, welds, adhesive or other fastening means. Nut clips 44 may likewise be secured over the openings 52 to provide a threaded opening for engaging screws.

Inasmuch as one or both of the front panels 36a, 36b may be removed routinely during use, any closure mechanisms for lids of cases for any case known in the art may be used in place of the illustrated tabs 42, 50.

In the illustrated embodiment, the rounded portions 40 have inset distal portions 56 extending distally therefrom. A portion of each inset distal portion 56 may be parallel to an inward facing surface of the panel 36c, 36d engaging the inset distal portion 56, i.e., substantially (e.g., within 5 degrees of) parallel to the vertical direction 12a and the longitudinal direction 12c. The inset distal portions 56 may be formed by bending, machining away portions of the rounded portions 40, or other manufacturing process such that the inset distal portions 56 are positioned inwardly along the horizontal direction 12b. When assembled, the left and right panels 36c, 36d may seat within the inset distal portions 56 and be held in place by means of screws, rivets, welds, adhesive, or other fastening means. For example, the inset distal portions 56 may define openings 58 that are aligned with openings 59 on a panel 36c, 36d secured to the inset distal portion 56. Nut clips 44 may be secured over the openings 58 in order to provide a threaded opening for receiving a screw. In some applications, disassembly of the panels 36c-36f is not performed by the user during use such that a permanent fastening means may be used.

The slides 32 may secure to any of the panels 36c-36f in positions corresponding to placement of the rails 20. In the illustrated embodiment, pairs of slides 32 are secured to each of the top panel 36e and bottom panel 36f by means of screws, rivets, welds, adhesive, or other fastening means. For example, the slides 32 may be made of a rigid polymer, such as nylon, acrylonitrile butadiene styrene (ABS), polyvinyl chloride (PVC), polyurethane, polypropylene, or the like, whereas the top panel 36e and bottom panel 36f are made of metal. The slides 32 may be secured to the top panel 36e and bottom panel 36f by means of screws, rivets, or other fastener that passes through a slide 32 and the panel 36e, 36f to which the slide 32 is secured. The slides 32 may be secured to the panels 36e, 36f either before or after assembly of the panels 36e, 36f to the panels 36c, 36d. When secured to the panels 36e, 36f, the slides 32 may extend along substantially all (e.g., at least 80 percent or at least 90 percent) of the depth of the panels 36e, 36f in the longitudinal direction 12c.

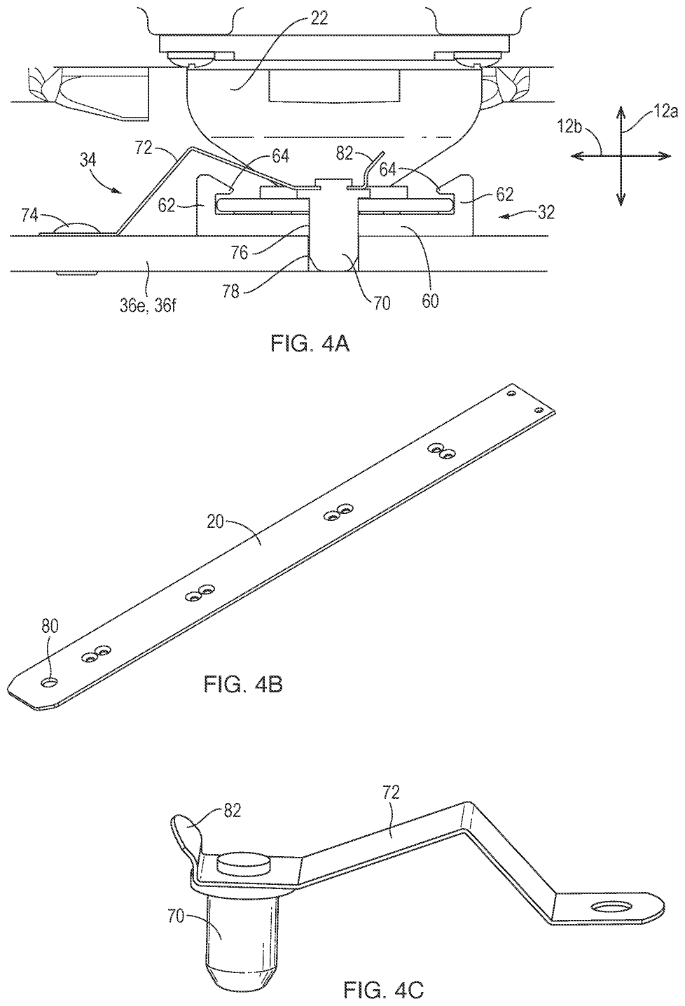

Referring to FIGS. 4A to 4C, resistance of movement of the inner enclosure 30 relative to the outer case 10 along the horizontal direction 12b may be accomplished by the engagement of the rails 20 with the slides 32. For example, the slide 32 may include a base 60 contacts and interfaces with the panel 36e, 36f to which the slide 32 is secured and receives any fastener used to secure the slide 32 to the panel 36e, 36f. The slide 32 may include sides 62 that extend outwardly from the base 60 (e.g., in the vertical direction 12a) and protrusions 64 that extend inwardly form the sides 32 and extend over the base 60 (e.g., in the horizontal direction 12b).

For the slides 32 secured to the top panel 36e and the bottom panel 36f, the sides 62 extend outwardly form the base 60 in the vertical direction 12a and the protrusions extending inwardly form the sides 62 in the horizontal direction 12b and are offset form the base in the vertical direction 12a. Accordingly, the sides 62 limit movement of the rail 20 relative to the slide 32 in the horizontal direction 12b and the protrusions 64 limit movement of the rail 20 relative to the slide 32 in the vertical direction 12a. As noted above, the cross section of the slide 32 may be substantially constant along substantially the entire length thereof, e.g., 90 percent or 80 percent.

A locking mechanism may be used to limit movement of the inner enclosure relative to the outer case 10. FIGS. 4A to 4C illustrate locking mechanism implemented as a clip 34. However, any locking mechanism, including screws or other types of clips may be used in a like manner.

The clip 34 may be implemented as a pin 70 secured to a spring arm 72 that is fixed at one end relative to the slide 32, such as due to fastening to the panel 36e, 36f to which the slide 32 is secured by means of a rivet 74, screw, or other fastening means. The spring arm 72 may include spring steel, composite material, or resilient polymer and is configured to bias the pin 70 toward the slide 32 and into an opening 76 formed in the slide 32. The pin 70 may have sufficient length to pass through the slide 32 and into an opening 78 formed in the panel 36e, 36f to which the slide 32 is secured. The pin 70 may have a tapered end to facilitate insertion into the openings 76, 78 during use. The rail 20 may include additional an 80 through which the pin 70 passes when the slider 32 is positioned over the rail 20 and the opening 80 is aligned with the opening 76 formed in the slide. The rail 20 may define additional openings for receiving fasteners securing the rail 20 to the shock absorbers 22. The spring arm 72 may have a tab 82 extending outwardly therefrom that may be engaged by the finger of a user to disengage the pin 70 from the openings 76, 78 and to pull the pin 70 out of the way when sliding the slider 32 over the rail 20.

As is apparent in FIGS. 4A and 4B, the rail 20 may be much wider (e.g., at least 4 times to at least 10 times) in the horizontal direction 12b than in the vertical direction 12a. This configuration may enable the rail 20 to have sufficient material to solidly engage the slide 32 while reducing the required gap between the slider 32 and the outer case 10.

In the illustrated configuration, the rail 20 inserts within the slide 32. However, other arrangements are possible. In other embodiments the slide 32 inserts within a rail 20 that includes sides 60 and inwardly extending protrusions. Likewise, other complimentary shapes for the rail 20 and slide 32 may be used in some embodiments.

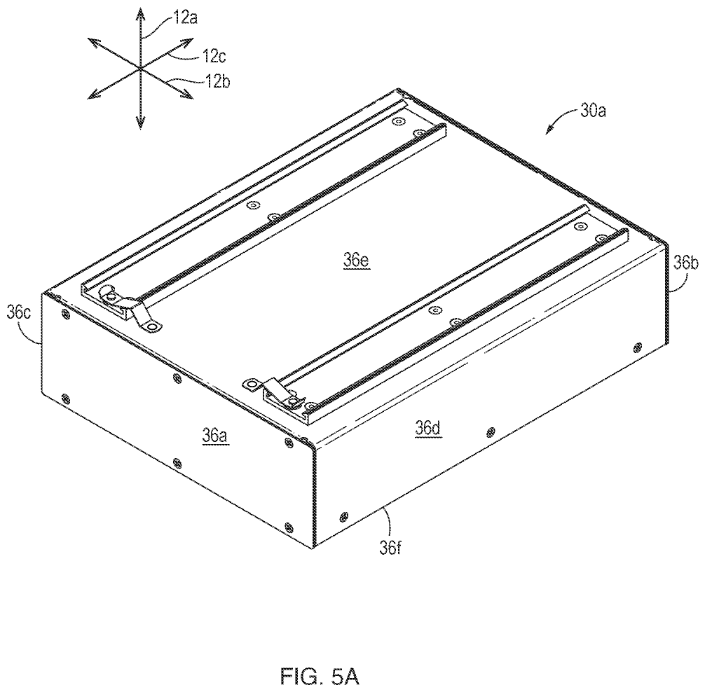

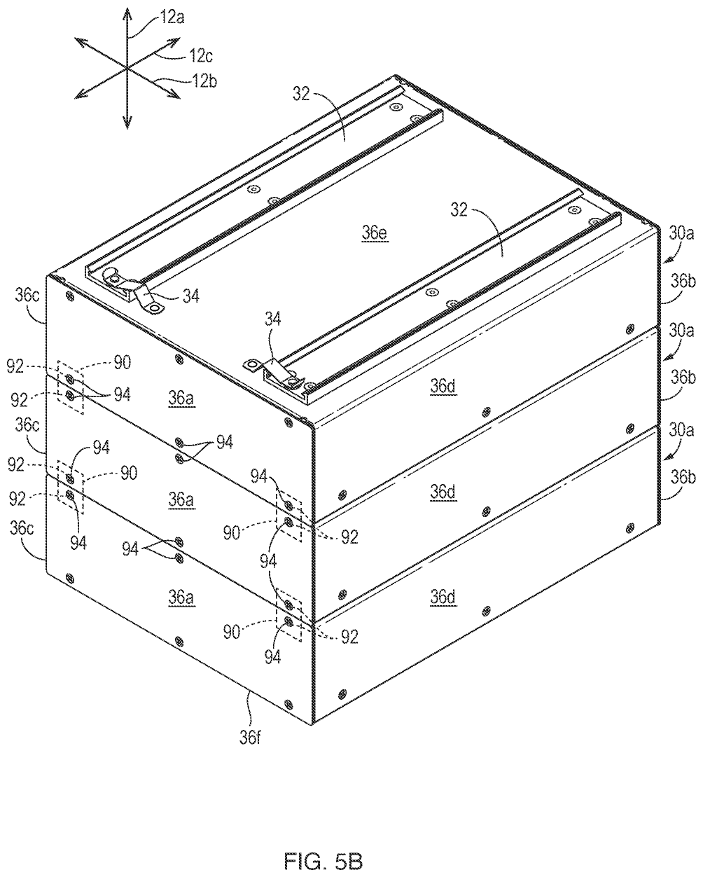

Referring to FIGS. 5A and 5B, in some embodiments, the inner enclosure 30 is implemented as a stack of two or more inner enclosures 30a-30c. In such embodiments, the slides 32 may secure to the top panel 36e of the upper enclosure 30a and to the bottom panel 36f of the lower enclosure 30c. The enclosures 30a-30c may be formed of discrete panels 36a-36f configured as described above with respect to FIG. 3 or configured according to some other approach. The inner enclosures 30a-30c may secure to one another by means of tabs 90 that secure to two contiguous inner enclosures of the two or more inner enclosures 30a-30c. For example, each tab 90 may include two openings 92 that may be aligned with two openings 94 on the two contiguous inner enclosures, one opening 94 on each of the inner enclosures 30a-30c to be joined by the tab 90. Two fasteners, such as screws, may then be inserted through the two openings 92 and two openings 94 to fasten the tab 90 to the two inner enclosures 30a-30c. In some embodiments, the tab 90 is permanently fastened to one of the two inner enclosures 30a-30c by means of welds, adhesive, or monolithic formation, such that only one fastener is used.

In the illustrated embodiment, the openings 94 are formed only on the front panels 36a of the inner enclosures 30a-30c. However, in other embodiments, openings 94 are formed on other panels 36b, 36c, 36d. Likewise, tabs 90 are only one example of an approach for securing inner enclosures 30a-30c to one another. For example, patterns of protrusions and recesses on one inner enclosure 30a, 30b may engage a pattern of protrusions and recesses on another inner enclosure 30b, 30c. Likewise, screws, rivets, welds, adhesive, or other permanent or selective fastening means may be used to secure inner enclosures 30a-30c to one another.

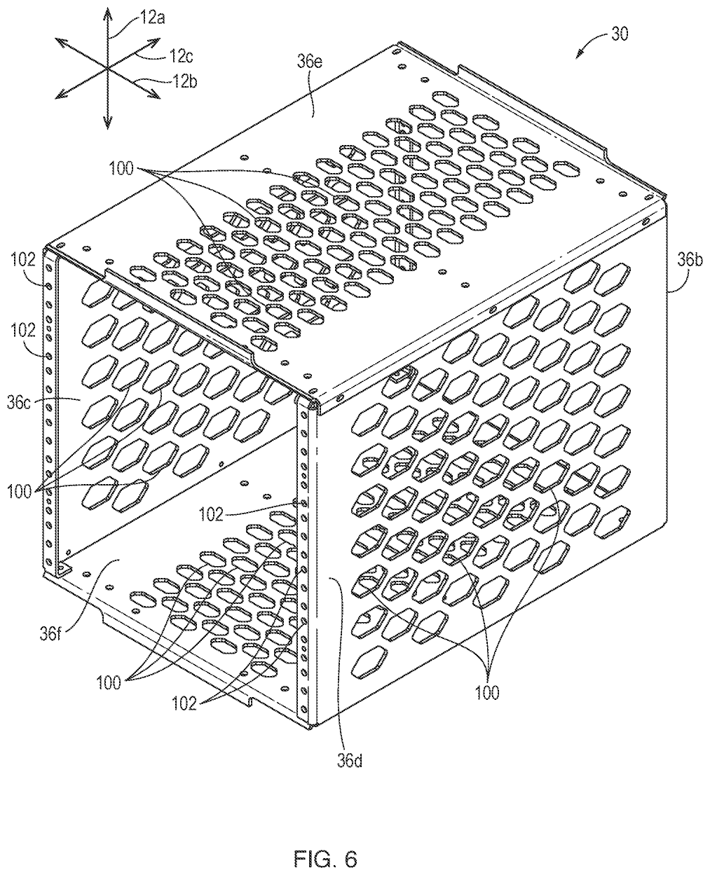

Referring to FIG. 6, in other embodiments, an inner enclosure 30 may include a plurality of windows 100. The windows 100 may form a mesh within some or all of the panels 36a-36f and occupying some or all, e.g., between 50 and 90 percent, of the panels 36a-36f in which the mesh is formed. For example, some of the panels 36a-36f may include windows 100 whereas others are solid. The size and distribution of the windows 100 may be selected to reduce the weight of the inner enclosure 30 while still providing a required degree of electromagnetic isolation within a desired range of wavelengths. In some embodiments, windows 100 are sized and positioned to provide clearance for protruding portions of a component positioned within the inner enclosure 30. FIG. 6 further illustrates that the inner enclosure 30 may be formed of panels 36c, 36d 36e, 36f may lack rounded portions 40, or include relatively small (e.g., less than 3 cm) rounded portions 30 at the transitions between the panels 36c, 36d 36e, 36f.

In any of the embodiments disclosed herein, one or both of the front panel 36a and the rear pane 136b may attach to two or more of the panels 36c, 36d, 36e, 36f using a standard interface for electronics enclosures. For example, openings 102 formed along edges of two or more of the panels 36c, 36d, 36e, 36f may conform to standards of one or more of the Electronic Industries Alliance, Consume Electronics Association, International Electrotechnical Commission, Deutsche Institut für Normung, or other standard. One or both of the front panel 36a and the rear panel 36b may have corresponding openings aligned to some or all of the openings 102 in order to receive fasteners securing one or both of the front panel 36a and the rear panel 36b to the two or more of the panels 36c, 36d, 36e, 36f.

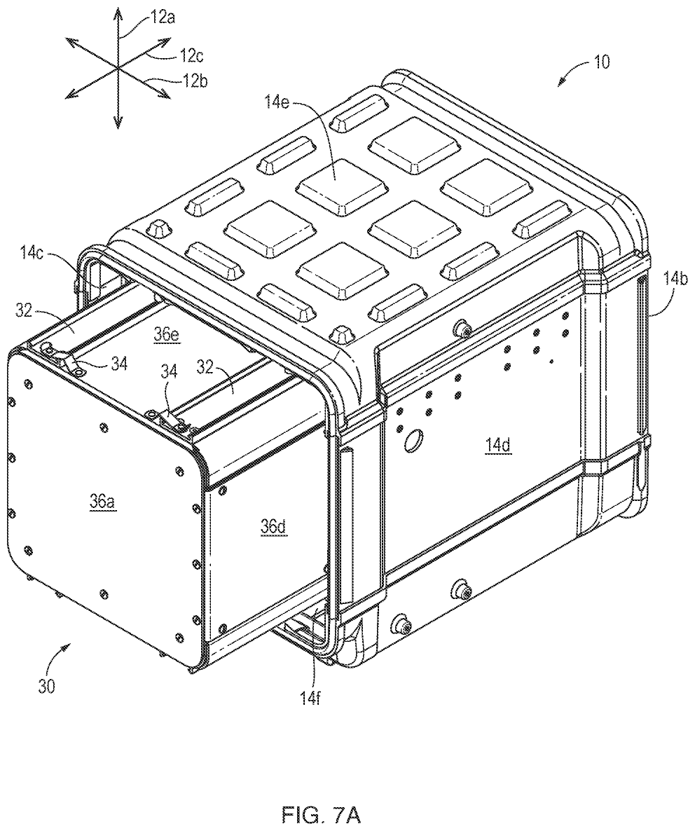

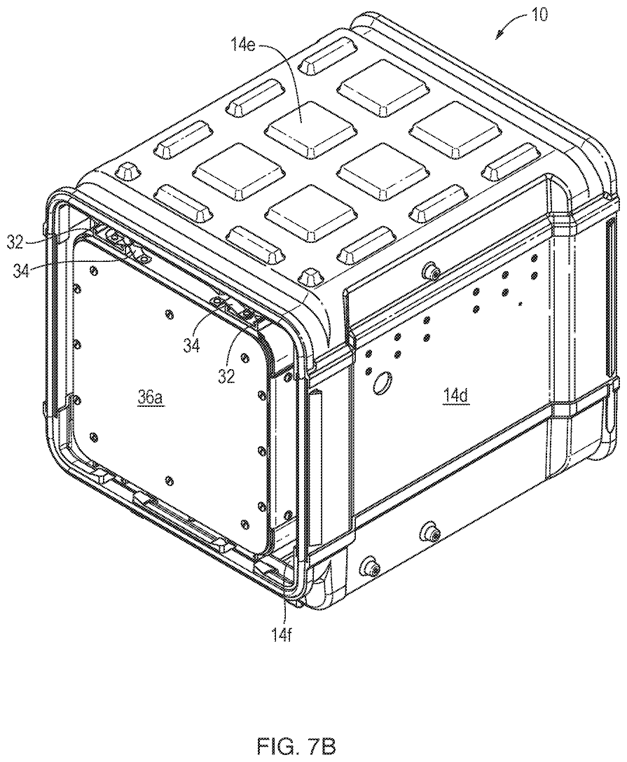

Referring to FIGS. 7A and 7B, in operation, the inner enclosure 30 is placed at the opening 14a of the outer case 10 and the sliders 32 are aligned with the rails 20 in the vertical direction 12a and the horizontal direction 12b. Tapering at ends of the rails 20 (see end of rail 20 in FIG. 4B) may tolerate some degree of misalignment in in the vertical direction 12a and the horizontal direction 12b, e.g., between 3 and 20 mm. Following alignment, the sliders 32 are slid into engagement with the rails 20, e.g., such that at least 80 percent of the length of the sliders 32 engaged with the rails 20. A lid may then be secured over the front opening 14a of the outer case.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. An apparatus for storing equipment comprising:
an outer case having a first substantially cuboid shape;
two or more rails mounted within the outer case and defining a longitudinal direction;
an inner enclosure sized to insert within the outer case and including a plurality of panels defining a second substantially cuboid shape; and
two or more sliders secured to the inner enclosure and directly interfacing with two or more outer surfaces of the plurality of panels, the two or more sliders configured to engage the two or more rails when the inner enclosure is inserted within the outer case along the longitudinal direction.

2. The apparatus of claim 1, wherein the two or more rails have a substantially constant cross section perpendicular to the longitudinal direction.

3. The apparatus of claim 1, wherein the two or more sliders have a substantially constant cross section perpendicular to the longitudinal direction.

4. The apparatus of claim 1, wherein the two or more sliders each include a base and sides extending outwardly from the base perpendicular to the longitudinal direction.

5. The apparatus of claim 4, wherein the two or more sliders each include protrusions extending inwardly from the sides, each rail positioned between the sides and under the protrusions of one slider of the two or more sliders when the inner enclosure is inserted within the outer case along the longitudinal direction.

6. The apparatus of claim 1, wherein no intervening frame is positioned between the outer case and the inner enclosure or between the two or more sliders and the inner enclosure.

7. The apparatus of claim 1, further comprising one or more locking mechanisms configured to prevent removal of the two or more sliders from engagement with the two or more rails when the inner enclosure is inserted within the outer case along the longitudinal direction.

8. The apparatus of claim 7, wherein each locking mechanism of the one or more locking mechanisms comprises a spring arm and a pin, the spring arm configured to urge the pin into engagement with a rail of the two or more rails and a slider of the two or more sliders engaged with the rail of the two or more rails.

9. The apparatus of claim 8, wherein each slider of the two or more sliders defines a slider opening sized to receive the pin of one of the one or more locking mechanisms and the plurality of panels define two or more panel openings each aligned with the slider opening of one of the two or more sliders.

10. The apparatus of claim 1, wherein:
the inner enclosure is one of a plurality of inner enclosures stacked together; and
the two or more sliders include one or more upper sliders mounted to a top inner enclosure of the plurality of inner enclosures and one or more lower sliders mounted to a lower inner enclosure of the plurality of inner enclosures.

11. A method for storing equipment comprising:
providing an outer case having a first substantially cuboid shape and having two or more rails mounted within the outer case and defining a longitudinal direction;
providing an inner enclosure sized to insert within the outer case and including a plurality of panels defining a second substantially cuboid shape, the inner enclosure having two or more sliders secured thereto and directly interfacing with two or more outer surfaces of the plurality of panels;
aligning the two or more sliders with the two or more rails; and
sliding the two or more sliders into engagement with the two or more rails with the inner enclosure positioned within the outer case.

12. The method of claim 11, wherein the two or more rails have a substantially constant cross section perpendicular to the longitudinal direction.

13. The method of claim 11, wherein the two or more sliders have a substantially constant cross section perpendicular to the longitudinal direction.

14. The method of claim 11, wherein the two or more sliders each include a base and sides extending outwardly from the base perpendicular to the longitudinal direction.

15. The method of claim 14, wherein the two or more sliders each include protrusions extending inwardly from the sides, each rail positioned between the sides and under the protrusions of one slider of the two or more sliders when the inner enclosure is inserted within the outer case along the longitudinal direction.

16. The method of claim 11, wherein no intervening frame is positioned between the outer case and the inner enclosure or between the two or more sliders and the inner enclosure when the inner enclosure is positioned within the outer case.

17. The method of claim 11, further comprising engaging one or more locking mechanisms with the two or more rails and the two or more sliders to prevent disengagement of the two or more rails from the two or more sliders when the inner enclosure is inserted within the outer case along the longitudinal direction.

18. The method of claim 17, wherein each locking mechanism of the one or more locking mechanisms comprises a spring arm and a pin, the method further comprising, biasing, by the spring arm of each locking mechanism, the pin of each locking mechanism into engagement with both of one of the two or more rails and one of the two or more sliders.

19. The method of claim 17, wherein each locking mechanism of the one or more locking mechanisms comprises a spring arm and a pin, the method further comprising, biasing, by the spring arm of each locking mechanism, the pin of each locking mechanism through a first opening in one of the two or more sliders and a second opening in one of the two or more rails.

20. The method of claim 11, wherein the inner enclosure is one of a plurality of inner enclosures, the method comprising securing the plurality of inner enclosures to one another having one or more upper sliders of the two or more sliders mounted to a top inner enclosure of the plurality of inner enclosures and one or more lower sliders of the two or more sliders mounted to a lower inner enclosure of the plurality of inner enclosures.

21. An apparatus for storing equipment comprising:
an inner enclosure sized to insert within an outer case defining a first substantially cuboid shape, the inner enclosure including a plurality of panels defining a second substantially cuboid shape; and
two or more sliders secured to the inner enclosure and directly interfacing with two or more outer surfaces of the plurality of panels, the two or more sliders configured to engage two or more rails mounted within the outer case when the inner enclosure is inserted within the outer case along a longitudinal direction.

22. The apparatus of claim 21, wherein the two or more sliders have a substantially constant cross section perpendicular to the longitudinal direction.

23. The apparatus of claim 21, wherein the two or more sliders each include a base, sides extending outwardly from the base perpendicular to the longitudinal direction, and protrusions extending inwardly from the sides such that each rail of the two or more rails is positioned between the sides and under the protrusions of one slider of the two or more sliders when the inner enclosure is inserted within the outer case along the longitudinal direction.

24. The apparatus of claim 21, wherein no intervening frame is positioned between the two or more sliders and the inner enclosure.

25. The apparatus of claim 21, further comprising one or more locking mechanisms configured to prevent removal of the two or more sliders from engagement with the two or more rails when the inner enclosure is inserted within the outer case along the longitudinal direction.
